(19) United States
(12) Patent Application Publication
(10) Pub. No.: US 2007/0280516 A1
(43) Pub. Date: Dec. 6, 2007

(54) Artificial Fingerprint Sticking Method, Artificial Fingerprint Sticking Apparatus, Artificial Fingerprint Wiping Method, And Artificial Fingerprint Wiping Apparatus

(75) Inventors: Kenji Yoneyama, Tokyo (JP); Takeshi Umega, Tokyo (JP); Naoki Hayashida, Tokyo (JP); Hidetake Itoh, Tokyo (JP); Kazushi Tanaka, Tokyo (JP); Mamoru Usami, Tokyo (JP); Kazuki Suzawa, Tokyo (JP)

Correspondence Address: OLIFF & BERRIDGE, PLC, P.O. BOX 19928, ALEXANDRIA, VA, 22320, US

(73) Assignee: TDK CORPORATION, Toyota (JP)

(21) Appl. No.: 11/547,615

(22) PCT Filed: Apr. 8, 2005
(86) PCT No.: PCT/JP05/06916

§ 371 Date: Oct. 5, 2006

(30) Foreign Application Priority Data
Apr. 8, 2004 (JP) 2004-113872
Apr. 8, 2004 (JP) 2004-113873
Apr. 8, 2004 (JP) 2004-113874
Apr. 8, 2004 (JP) 2004-113875

(51) Int. Cl. G06K 9/00

(52) U.S. Cl. 382/126

(57) ABSTRACT

An object is to stick an artificial fingerprint liquid on a test sample in a constant condition. An artificial fingerprint stamping apparatus 1 operates such that as an arm 10 lowers, the self weight of a stamp unit 3 causes an artificial fingerprint transfer member 9 at the lower end of a stamp pin 6 attached to the arm 10 via a ball bush 11 to be pressed against an artificial fingerprint liquid transfer disk D1 for a predefined period of time, and thus an artificial fingerprint liquid is transferred onto the lower end surface of the artificial fingerprint transfer member 9. Then, after the artificial fingerprint transfer member 9 is positioned above a test disc D1, the arm 10 is lowered so that the self weight of the stamp unit 3 causes the artificial fingerprint transfer member 9 to be pressed against the test disc D1 for a predefined period of time.

### TECHNICAL FIELD

The present invention relates to an artificial fingerprint sticking method and an artificial fingerprint sticking apparatus for sticking an artificial fingerprint onto a test sample, and an artificial fingerprint wiping method and an artificial fingerprint wiping apparatus for wiping an artificial fingerprint liquid off a test sample stuck with the artificial fingerprint liquid in order to evaluate the ease of wiping fingerprints. The present invention is typically employed to evaluate optical discs such as CDs and DVDs.

### BACKGROUND ART

Optical discs such as CDs and DVDs are sensitive to contaminants or scratches on their surface. In recent years, higher-density optical discs are in increasing demand to store a massive amount of information (typically information about moving images). Those optical discs become more sensitive to contaminants such as dust or fingerprints or scratches sticking on the surface upon which a laser beam is incident because the read/write beam is reduced in focused spot diameter with increasing recording densities. In this context, it has been suggested to coat the surface of optical discs with hard coat or the like.

In the course of development of optical discs, to evaluate the measures taken against contaminants or scratches on the surface, for example, against contaminants, fingerprints have been actually stuck thereon to visually evaluate the ease of wiping them. However, it is difficult to make objective evaluations using human fingerprints because of their variations among individuals.

To ensure objective evaluations, it has been practiced to prepare an artificial fingerprint liquid having a small amount of sodium chloride, urea, and lactic acid dissolved in a liquid mixture of water and ethanol, so that this artificial fingerprint liquid is stuck onto a surface of an optical disc, thereby visually evaluating the ease of wiping fingerprints. In Japanese Patent Laid-Open Publication No. 2003-168248, such an artificial fingerprint liquid has also been suggested which is closely analogous to human fingerprints in property.

In typical application examples, the artificial fingerprint liquid makes it possible, to some extent, to perform objective evaluations of the dirt repellence, ease of sticking fingerprints, and ease of wiping fingerprints on optical discs. However, it is not possible to ensure objective evaluations unless the artificial fingerprint liquid is stuck onto a test sample under a constant condition.

Furthermore, the artificial fingerprint liquid makes it possible, to some extent, to perform objective evaluations of the ease of wiping fingerprints on optical discs. However, in order to ensure objective evaluations of the ease of wiping fingerprints sticking on an optical disc under test, it is necessary to ensure the reproducibility of wiping.

### DISCLOSURE OF INVENTION

It is therefore an object of the present invention to provide an artificial fingerprint sticking method and an artificial fingerprint sticking apparatus which allow an artificial fingerprint liquid to stick onto a test sample such as an optical disc under a constant condition.

It is another object of the present invention to provide an artificial fingerprint wiping method and an artificial fingerprint wiping apparatus which allow an artificial fingerprint sticking on a test sample such as an optical disc to be wiped under a constant condition.

According to a first aspect of the present invention, such a technical object can be achieved by an artificial fingerprint sticking method, in which an artificial fingerprint transfer member provided at a lower end of a stamp unit is pressed against a surface of a test sample, thereby allowing an artificial fingerprint liquid sticking on the artificial fingerprint transfer member to be stuck onto the surface of the test sample. The artificial fingerprint sticking method comprises:

preparing an artificial fingerprint liquid transfer source;

positioning the artificial fingerprint liquid transfer source under the stamp unit;

lowering the stamp unit so that substantially a self weight of the stamp unit causes the artificial fingerprint transfer member to be pressed against the artificial fingerprint liquid transfer source for a predetermined time and lifting the stamp unit after the artificial fingerprint liquid is stuck onto the artificial fingerprint transfer member;

positioning the test sample under the stamp unit;

lowering the stamp unit so that substantially the self weight of the stamp unit causes the artificial fingerprint transfer member to be pressed against the test sample for a predetermined time and lifting the stamp unit after the artificial fingerprint liquid is stuck onto a surface of the test sample; and

removing the test sample stuck with the artificial fingerprint liquid from under the stamp unit.

Furthermore, according to a second aspect of the present invention, the aforementioned technical object can be achieved by an artificial fingerprint sticking apparatus for sticking a desired amount of artificial fingerprint liquid onto a surface of a test sample. The artificial fingerprint sticking apparatus includes:

a stamp unit provided at its lower end with an artificial fingerprint transfer member,

a stamp unit support for supporting the stamp unit to be slidable up and down, and

an up-and-down movement actuator for driving the stamp unit support up and down.

The artificial fingerprint sticking apparatus is configured such that the up-and-down movement actuator is operated to thereby lower the stamp unit support allowing the artificial fingerprint transfer member of the stamp unit to sit on the test sample, so that substantially the self weight of the stamp unit causes the artificial fingerprint transfer member stuck with a predetermined amount of artificial fingerprint liquid to be pressed against a surface of the test sample in order to allow the artificial fingerprint liquid on the artificial fingerprint transfer member to stick onto the surface of the test sample.

That is, according to the present invention, since the self weight of the stamp unit is used to stick an artificial fingerprint liquid onto a surface of a test sample, the artificial fingerprint can be stuck onto the test sample under a constant condition, thereby ensuring objective evaluations.

In the artificial fingerprint sticking method and the artificial fingerprint sticking apparatus of the present invention, the stamp unit preferably has a weight adjustment member such as a weight so that the self weight of the stamp unit is adjustable. Additionally, the user is preferably allowed to define the time during which the artificial fingerprint transfer member is pressed against the test sample.

A preferred embodiment of the present invention provides control means for controlling the up-and-down movement actuator. The control means preferably includes, e.g., timer setting means by which a user defines the time during which the stamp unit support is lowered to cause the artificial fingerprint transfer member to be pressed against an artificial fingerprint liquid transfer disk and a test optical disc. This allows for defining times which are each suitable for each one of various evaluations, thus specifying the time during which the artificial fingerprint transfer member is pressed against the artificial fingerprint liquid transfer disk as well as the time during which it is pressed against a test optical disc.

Furthermore, a preferred embodiment of the present invention employs a silicone rubber of a hardness of 40 to 80 HS as a material of the artificial fingerprint transfer member.

Additionally, it is possible to ensure the constancy and reproducibility of sticking of an artificial fingerprint liquid by employing a predetermined rough surface as the transfer surface or the lower end surface of the artificial fingerprint transfer member for carrying the artificial fingerprint liquid. The artificial fingerprint transfer member is typically formed of an elastomer material (typically, silicone rubber).

Furthermore, according to a third aspect of the present invention, the aforementioned technical object can be achieved by an artificial fingerprint wiping method, in which an artificial fingerprint transfer member provided at a lower end of a stamp unit is pressed against a surface of a test sample to allow an artificial fingerprint liquid sticking on the artificial fingerprint transfer member to be stuck onto the surface of the test sample, and then the artificial fingerprint liquid sticking on the test sample is wiped. The artificial fingerprint wiping method includes preparing an artificial fingerprint liquid transfer source;

positioning the artificial fingerprint liquid transfer source under the stamp unit;

lowering the stamp unit so that a self weight of the stamp unit causes the artificial fingerprint transfer member to be pressed against the artificial fingerprint liquid transfer source for a predetermined time and lifting the stamp unit after the artificial fingerprint is stuck onto the artificial fingerprint transfer member;

positioning the test sample under the stamp unit;

lowering the stamp unit so that substantially the self weight of the stamp unit causes the artificial fingerprint transfer member to be pressed against the test sample for a predetermined time and lifting the stamp unit after the artificial fingerprint liquid is stuck onto the surface of the test sample;

removing the test sample stuck with the artificial fingerprint liquid from under the stamp unit;

under a constant load, placing a wiping member on the test sample stuck with the artificial fingerprint liquid;

allowing the wiping member and the test sample to move relative to each other under a specified condition in order to wipe the artificial fingerprint liquid off the test sample.

According to the artificial fingerprint wiping method of the present invention, an artificial fingerprint can be stuck onto a test sample under a constant condition as well as can be wiped under a constant condition. It is thus realized not only to perform objective evaluations on the ease of wiping fingerprints but also to ensure the objective evaluations with increased certainty.

Furthermore, according to a fourth aspect of the present invention, such a technical object can be achieved by providing an artificial fingerprint wiping apparatus for wiping an artificial fingerprint liquid, under a specified condition, off a surface of a test sample stuck with a predetermined amount of the artificial fingerprint liquid. The artificial fingerprint wiping apparatus includes:

a test sample table for a test sample stuck with the artificial fingerprint to stay on;

a wiping member to be brought under a load into contact with the surface of the test sample staying on the test sample table; and

a drive mechanism for driving the wiping member and the test sample table to move relative to each other under a certain condition, wherein

the load applied to the wiping member and an operating condition of the drive mechanism are adjustable.

According to the artificial fingerprint wiping apparatus of the present invention, fingerprints can be wiped under a constant condition, thereby performing objective evaluations on the ease of wiping fingerprints. As a preferred embodiment, to ensure the constancy, it is preferable to use an artificial fingerprint sticking apparatus for sticking a predetermined amount of artificial fingerprint liquid onto test samples.

That is, as a preferred artificial fingerprint sticking apparatus, such an artificial fingerprint sticking apparatus may be employed which includes a stamp unit provided at its lower end with an artificial fingerprint transfer member;

a stamp unit support for supporting the stamp unit to be slidable up and down, and

an up-and-down movement actuator for driving the stamp unit support up and down. The artificial fingerprint sticking apparatus is configured such that the up-and-down movement actuator is operated to thereby lower the stamp unit support allowing an artificial fingerprint transfer member of the stamp unit to sit on the test sample, so that substantially the self weight of the stamp unit causes the artificial fingerprint transfer member stuck with a predetermined amount of artificial fingerprint liquid to be pressed against a surface of the test sample in order to allow the artificial fingerprint liquid on the artificial fingerprint transfer member to stick onto the surface of the test sample.

With the artificial fingerprint wiping apparatus, the wiping member and the test sample table may be moved relative to each other horizontally back and forth to wipe fingerprints. Alternatively, the wiping member and the test sample table may also be driven to rotate relative to each other to wipe fingerprints.

The number of times of back-and-forth movements and the number of times of relative rotations maybe predefined; however, they are preferably defined by the user as appropriate.

### BRIEF DESCRIPTION OF THE DRAWINGS

FIG. 1 is a schematic view showing an artificial fingerprint sticking apparatus according to an example;

FIG. 2 is a plan view showing the artificial fingerprint sticking apparatus of FIG. 1 when viewed from above;

FIG. 3 is an explanatory view showing a first step of the artificial fingerprint sticking apparatus according to the example;

FIG. 4 is an explanatory view showing a second step of the artificial fingerprint sticking apparatus according to the example;

FIG. 5 is an explanatory view showing a third step of the artificial fingerprint sticking apparatus according to the example;

FIG. 6 is the explanatory view showing a fourth step of the artificial fingerprint sticking apparatus according to an example; and

FIG. 7 is a view showing the overall configuration of an artificial fingerprint wiping apparatus that is preferably used in conjunction with the artificial fingerprint sticking apparatus.

### BEST MODE FOR CARRYING OUT THE INVENTION

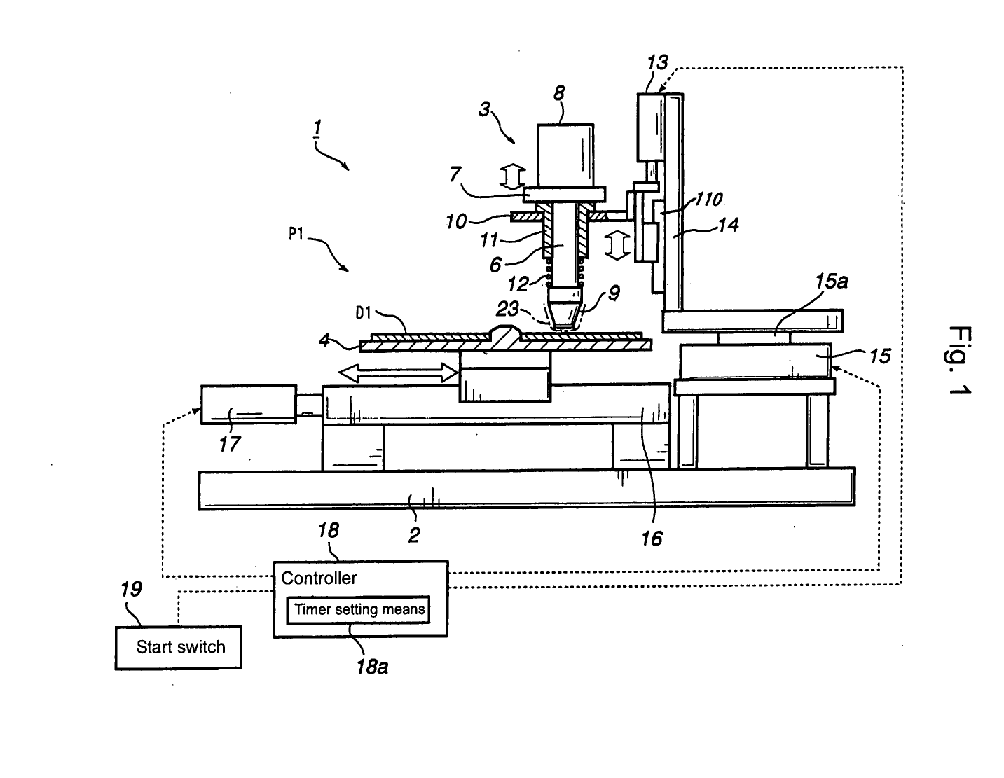

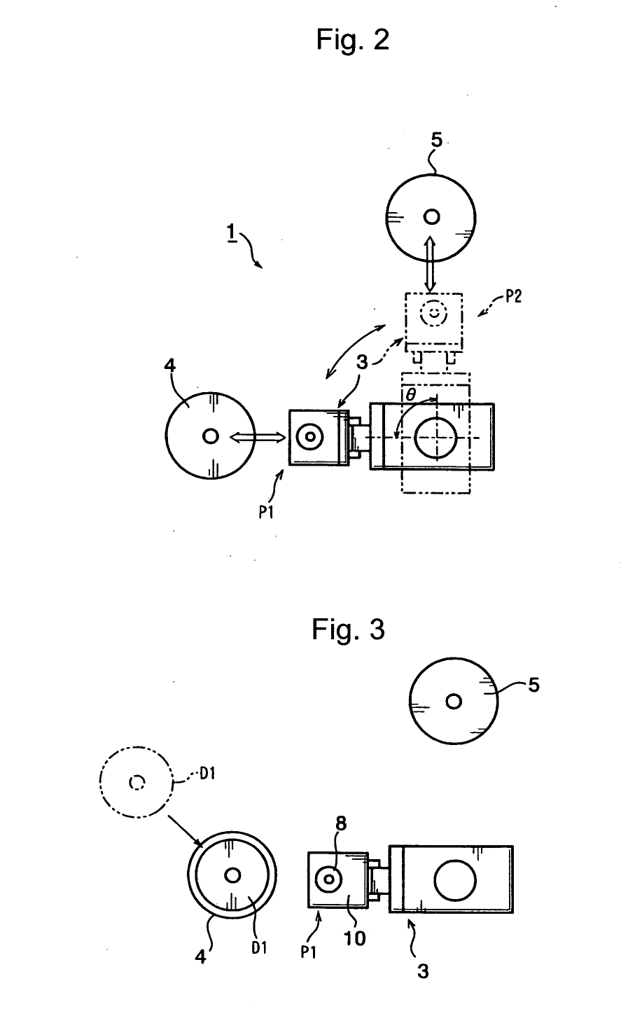

FIG. 1 is a schematic view showing an artificial fingerprint sticking apparatus, and FIG. 2 is its plan view. As a specific application example, the shown artificial fingerprint sticking apparatus 1 is used to perform evaluations on optical discs such as DVDs.

Referring to FIGS. 1 and 2, the artificial fingerprint sticking apparatus 1 includes a stamp unit 3 which is provided on a base 2, a sample disc (test sample) table 4, and an artificial fingerprint liquid transfer disk table 5. The stamp unit 3 includes a vertically extending stamp pin 6, a horizontal table (a weight table) 7 provided on the upper end of the stamp pin 6, and a weight (a weight adjustment member) 8 capable of staying on the horizontal table 7 for adjusting the weight of the stamp unit 3.

The stamp pin 6 is provided at its lower end with an artificial fingerprint transfer member 9. The artificial fingerprint transfer member 9 may be attached to the stamp pin 6 so as to be replaceable; however, in this example, the artificial fingerprint transfer member 9 is attached using an adhesive or the like, and will be replaced, if worn, together with the stamp pin 6.

The stamp pin 6 is attached to an arm (stamp unit support) 10 via a ball bush 11, while a cushion spring 12 of relatively low resilience is interposed between the ball bush 11 and the artificial fingerprint transfer member 9. The arm 10 can be guided by a slide guide 110 to move up and down and is driven by a vertical cylinder (or an up-and-down movement actuator) 13. The slide guide 110 is securely provided to a rotor 14, and the rotor 14 is coupled to a vertically extending output shaft 15a of a rotary actuator 15. The rotary actuator 15 can take first and second rotational positions P1 and P2, and its rotational angle 0 is, but not especially limited to, set at 90° (FIG. 2).

The sample disc table 4 is provided adjacent to the first rotational position P1, and an optical information medium D1 such as a read-only optical disc or an optical storage disc to be tested (hereinafter, referred to as a “test disc”) can be detachably set onto the sample disc table 4. Additionally, the artificial fingerprint liquid transfer disk table 5 is provided adjacent to the second rotational position P2, and an artificial fingerprint liquid transfer disk (an artificial fingerprint liquid transfer source) D2, on which an artificial fingerprint liquid is applied, can be detachably set onto the artificial fingerprint liquid transfer disk table 5.

Referring to FIG. 1, the sample disc table 4 may be manually operated, but may be preferably capable of moving towards and from the stamp unit 3 via a horizontal ball slide shaft 16 that extends radially towards a rotary actuator output shaft 15, and the ball slide shaft 16 is rotatably driven by a servo motor 17. The artificial fingerprint liquid transfer disk table 5 may also be manually operated, but may be preferably configured in the same manner as the sample disc table 4 so as to be motor driven and thus capable of moving towards and from the stamp unit 3.

The artificial fingerprint sticking apparatus 1 is controlled by a controller 18. The controller 18 includes a manual start switch 19 and timer setting means 18a, where the timer setting means 18a allows the user to set any operation timing of various actuators and time for stopping the operation.

The artificial fingerprint sticking apparatus 1 is used to allow an artificial fingerprint to stick onto the test disc D1 under a specified condition to evaluate the dirt repellence (typically, to fingerprints) of or the ease of wiping dirt on the surface of, e.g., a DVD or Blu-ray (registered trademark) disc, upon which a laser beam is incident.

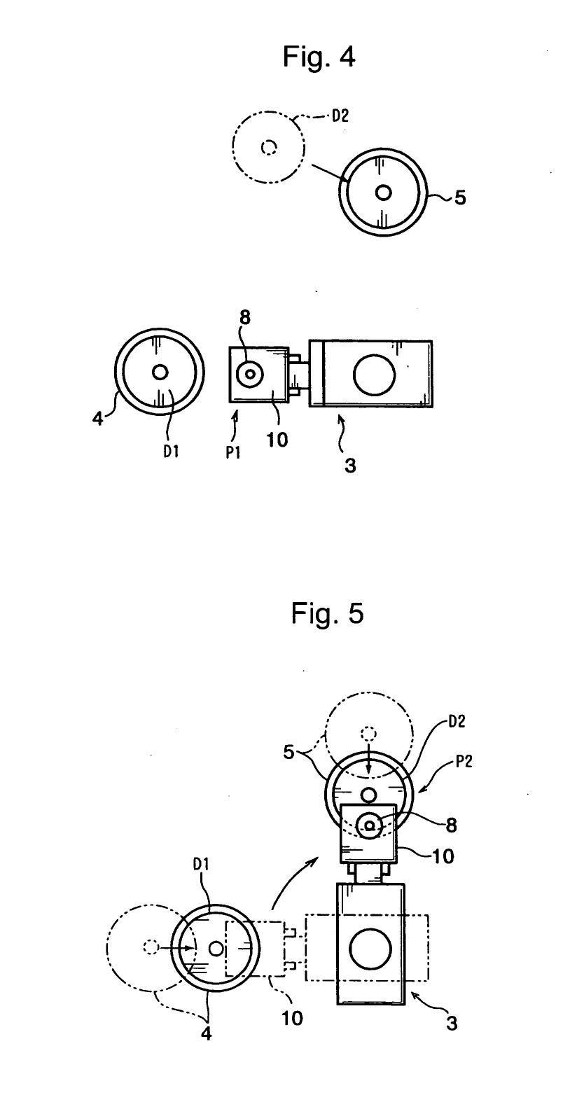

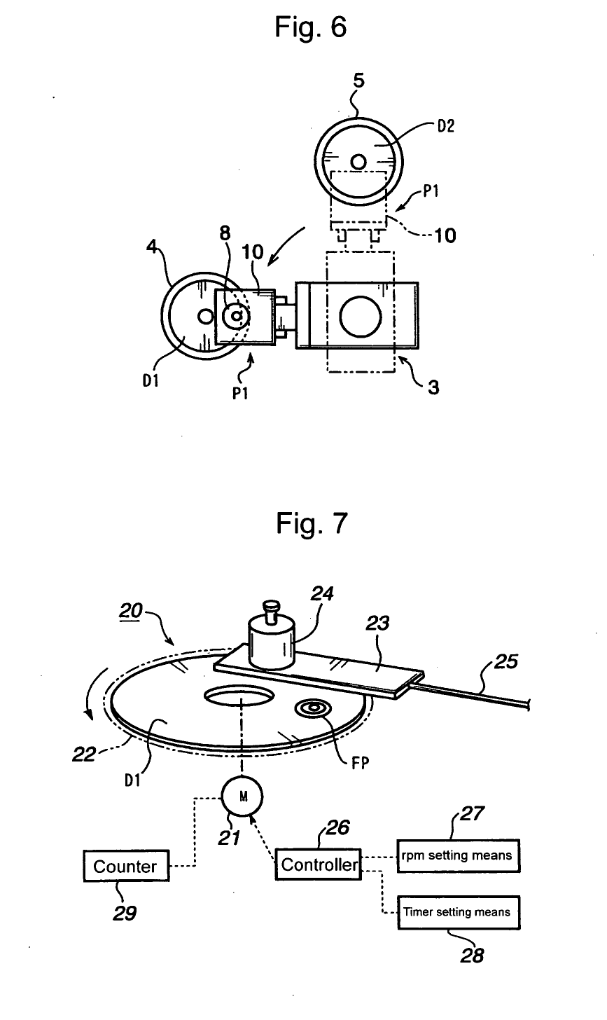

Referring to FIGS. 3 to 6, an explanation will now be made to the process steps for allowing an artificial fingerprint to stick onto the test disc D1 using the artificial fingerprint sticking apparatus 1. FIGS. 3 to 6 correspond to the order of the steps, thus FIG. 3 showing the first step, FIG. 4 showing the second step, FIG. 5 showing the third step, FIG. 6 showing the fourth step.

In the first step of FIG. 3, the sample disc table 4 is located at an original position (in a standby area) away from the stamp unit 3, and the test disc D1 is placed on the sample disc table 4 that is located in the standby area. On the other hand, the stamp unit 3 is on standby at the first rotational position P1 that corresponds to the sample disc table 4.

In the next second step (FIG. 4), the artificial fingerprint liquid transfer disk table 5 is located at an original position (in a standby area) apart from the stamp unit 3, and an artificial fingerprint liquid transfer disk D2 is placed on the artificial fingerprint liquid transfer disk table 5 located in the standby area.

In the next third step (in FIG. 5), the user may turn on a start switch (not shown), thereby allowing the artificial fingerprint sticking apparatus 1 to start operating. Turning ON the start switch causes the sample disc table 4 and the artificial fingerprint liquid transfer disk table 5 to move to a position in an inner area, where the stamp unit 3 is approachable to them, i.e., a stamping position or a transfer position (the positions indicated by solid lines in FIG. 5). Then, the stamp unit 3 rotates by 90° in a clockwise direction allowing the artificial fingerprint transfer member 9 to be positioned above the artificial fingerprint liquid transfer disk D2, and thereafter, the stamp pin 6 lowers to cause the artificial fingerprint transfer member 9 to be pressed against the artificial fingerprint liquid transfer disk D2. The impact caused by the stamp pin 6 being lowered to bring the artificial fingerprint transfer member 9 into contact with the artificial fingerprint liquid transfer disk D2 is alleviated by the cushion spring 12. In this manner, the artificial fingerprint transfer member 9 is pressed against the artificial fingerprint liquid transfer disk D2, thereby allowing an artificial fingerprint liquid on the artificial fingerprint liquid transfer disk D2 to be transferred onto the lower end surface of the artificial fingerprint transfer member 9. Using the timer setting means 18a, the user can set any period of transfer time during which the artificial fingerprint transfer member 9 is kept pressed against the artificial fingerprint liquid transfer disk D2.

When the user-defined predetermined transfer time has elapsed, the process proceeds to the next fourth step (FIG. 6). In the fourth step, the stamp pin 6 starts moving up to return to a standby position, then the stamp unit 3 rotates by 90° in a counterclockwise direction thereby allowing the artificial fingerprint transfer member 9 to be positioned above the test disc D1. Then, the stamp pin 6 lowers to press the artificial fingerprint transfer member 9 against the test disc D1. The impact caused by the stamp pin 6 being lowered to bring the artificial fingerprint transfer member 9 into contact with the test disc D1 is alleviated by the cushion spring 12. The artificial fingerprint transfer member 9 stuck with the artificial fingerprint liquid is pressed against the test disc D1, thereby allowing for stamping an artificial fingerprint onto the surface of the test disc D1.

The stamping force exerted by the artificial fingerprint transfer member 9, i.e., the force by which the artificial fingerprint transfer member 9 is pressed against the test disc D1 is substantially defined by the self weight of the stamp unit 3 including the weight 8. Using the timer setting means 18a, the user can set any period of stamping time during which the artificial fingerprint transfer member 9 is kept pressed against the test disc D1. When the stamping time has elapsed, the stamp pin 6 goes up to return to the standby position, and the sample disc table 4 and the artificial fingerprint liquid transfer disk table 5 move outwardly from the stamping position or the transfer position back to the original position (the standby area) and then go into a standby state (the state in the second step of FIG. 4).

The test disc D1 having been stamped with the artificial fingerprint is removed from the sample disc table 4 and provided for various evaluations. On the other hand, the artificial fingerprint sticking apparatus 1 is in the standby state, during which the artificial fingerprint liquid remaining on the artificial fingerprint transfer member 9 may be removed, e.g., using a cloth moistened with an ethanol solution (a cleaning step). In the cleaning step, the artificial fingerprint liquid may be wiped off the artificial fingerprint transfer member 9 using a cloth or a piece of paper without using a washing solution, thereby removing the artificial fingerprint liquid remaining on the artificial fingerprint transfer member 9.

Furthermore, before the next test disc D1 is stamped with an artificial fingerprint, the artificial fingerprint liquid transfer disk table 5 may be slightly rotated to displace in order to avoid the artificial fingerprint transfer member 9 from repeatedly performing transfer operations at the same place on the artificial fingerprint liquid transfer disk D2. Alternatively, the servo motor 17 may be activated to slightly displace the artificial fingerprint liquid transfer disk table 5.

As the basic concept is disclosed in Japanese Patent Laid-Open Publication No. 2003-168248, the artificial fingerprint liquid that can be preferably used with the artificial fingerprint sticking apparatus 1 may have a property that is analogous to that of human fingerprints. For example, fine particle substances and a dispersion medium that can disperse the fine particle substances may be used to provide a property analogous to that of human fingerprints.

Such an artificial fingerprint liquid having a property analogous to that of human fingerprints can be preferably used to perform various evaluations of, e.g., the dirt repellence, ease of sticking fingerprints, and ease of removing of fingerprints (ease of wiping fingerprints) on CDs or DVDs. The artificial fingerprint liquid having a property analogous to that of human fingerprints includes fine particle substances, a dispersion medium that can disperse the fine particle substances, and a diluent added as required.

A fine particle substance, a component of an artificial fingerprint liquid, has at least one type of fine particle selected from the group consisting of inorganic fine particles and organic fine particles. By way of example, an inorganic fine particle may include silica fine particles, alumina fine particles, iron oxide fine particles, and a mixture of any two or more types of fine particles selected from the group consisting thereof. On the other hand, by way of example, an organic fine particle may include chitin fine particles, chitosan fine particles, acrylic-based fine particles, styrene-based fine particles, divinylbenzene-based fine particles, polyamide-based fine particles, polyimide-based fine particles, polyurethane-based fine particles, melamine-based fine particles, and a mixture of any two or more types of these fine particles selected from the group consisting thereof. In terms of performance stability of the artificial fingerprint liquid, the content of inorganic fine particles of all the fine particle substances contained in the artificial fingerprint liquid may be 50 wt % or more, and preferably 80 wt % or more, or 100 wt % with respect to the total fine particle substances.

The fine particle substance may have an average particle diameter of 0.05 to 100 μm, preferably 0.05 to 50 μm, more preferably 0.05 to 30 μm, and most preferably, 0.5 to 10 μm. The JISZ8901 test powders 1 and 2 can be employed as commercially available fine particle substances. Alternatively, the ISO test powder 12103-1, and the standard powder recommended by The Association of Powder Process Industry and Engineering, Japan (APPIE) can be employed. All of them can be employed as a fine particle component of an artificial fingerprint liquid. Of the JISZ8901 test powders 1, the most preferable one is Kanto-Loam. It is also acceptable to select at least one type of inorganic fine particles contained in the aforementioned test powder, e.g., at least one type of SiO₂, Fe₂O₃, and Al₂O₃.

The fine particle substance may have a critical surface tension of 40 mNm⁻¹ or more at 25° C. and preferably 50 mNm⁻¹ or more, and is preferably greater than the surface tension of the dispersion medium at 25° C.

By way of example, the dispersion medium or a component of the artificial fingerprint liquid may include higher fatty acid, a derivative of the higher fatty acid, tenpenes, or a derivative of the tenpenes, and has preferably a range of surface tensions from 20 to 50 mNm⁻¹ at 25° C. The higher fatty acid may include oleic acid, linoleic acid, or linolenic acid. The derivative of the higher fatty acid may include an ester derivative such as a diglyceride derivative and a triglyceride derivative (typically, triolein). The tenpenes may include squalene, limonene, α-pinene, β-pinene, camphene, linalool, terpineol, and cadinene, for example.

The dispersion medium contained in the artificial fingerprint liquid may have a viscosity of 500 cP or less, preferably 0.5 to 300 cP, and more preferably 5 to 250 cP at 25° C. Controlling the viscosity of the dispersion medium in this manner allows the fine particle substances to be well dispersed even after an artificial fingerprint is stamped on the test disc D1 as well as allows the stamped artificial fingerprint to be fixed on the surface of the test disc D1. In general, the mixing ratio of fine particle substances and a dispersion medium cannot be unexceptionally specified, but the ratio between the fine particle substances and the dispersion medium may be 0.1 to 5.0:1 by weight, preferably 0.1 to 3.0:1, and more preferably 0.2 to 1.0:1.

Natural or synthetic wax, a thickener such as carrageenan or gum arabic, or a surface-active agent such as quaternary ammonium salt or alkylbenzene sulfonate may be added to the artificial fingerprint liquid that can be used with the artificial fingerprint sticking apparatus 1, or the liquid may be diluted with isopropyl alcohol or methyl ethyl ketone or the like. The basic concept of artificial fingerprint liquids is described in Japanese Patent Laid-Open Publication No. 2003-168248, the entirety of which is incorporated herein by reference.

The artificial fingerprint transfer member 9 may be formed of a hard material such as metal, but may also be preferably formed of a material of adequate elasticity. More specifically, the artificial fingerprint transfer member 9 may be formed of a material selected from various elastomer materials. The elastomer materials may be butadiene rubber, urethane rubber, and silicone rubber, in the case of which the silicone rubber is preferably employed.

The artificial fingerprint transfer member 9 may have a cylindrical shape or a conical shape gradually reduced downwardly in diameter, and the artificial fingerprint transfer member 9 formed of an elastomer material such as silicone rubber may have a height of 5 to 30 mm, preferably 5 to 25 mm, and more preferably 10 to 25 mm. In a case where the artificial fingerprint transfer member 9 formed of silicone rubber or the like has an excessively short height, a material for attaching the artificial fingerprint transfer member 9 to the stamp pin 6, e.g., adhesive for attaching silicone rubber to the lower end surface of the stamp pin 6, the adhesive would readily cause an adverse effect. On the other hand, an excessively large height would readily lead to variations in stamping conditions due to deflection caused by the load imposed during stamping. Taking the size of human fingers into account, the lower end surface (transfer surface) of the artificial fingerprint transfer member 9 may have a diameter of about 5 to 20 mm, and preferably about 7 to 15 mm. In terms of area, the lower end surface (transfer surface) of the artificial fingerprint transfer member 9 may have an area of about 20 to 300 mm², and preferably about 40 to 200 mm².

As described above, the length of the artificial fingerprint transfer member 9 formed of an elastomer material and the diameter or area of the transfer surface can be specified to thereby realize a condition analogous to a situation of stamping with a human finger. The artificial fingerprint transfer member 9, especially when formed of an elastomer material (typically, silicone rubber), may have a Shore hardness of 40 to 80 HS. Incidentally, the silicone rubber actually employed for the artificial fingerprint transfer member 9 in a prototype set has a Shore hardness of about 60 HS.

The roughness of the lower end surface of the artificial fingerprint transfer member 9, i.e., the transfer surface may be unchanged from that of the molded silicone rubber (of a surface roughness of about 0.6 to 0.7 μm) especially when an elastomer material (typically, silicone rubber) is employed for the artificial fingerprint transfer member 9. However, the lower end surface (transfer surface) can be preferably made rough as appropriate for uniform transfer of the artificial fingerprint liquid. As a method of making a rough surface, the AA240 abrasive specified in JISR625 or JISR252 or an equivalent abrasive may be used to rub the surface to make it rough, so that the lower end surface of the artificial fingerprint transfer member 9 has preferably a roughness Ra (an arithmetic average roughness specified in JIS B 0601-1994) of about 1.5 to 4.5 μm or more, and more preferably about 1.5 to 4.2 μm. Accordingly, the artificial fingerprint transfer member 9 formed of an elastomer material may have an average roughness within a range of about 0.6 to 4.5 μm (an average height of bumps and dips) so that the artificial fingerprint liquid can uniformly stick on the lower end surface to thereby uniformly stick an artificial fingerprint onto a test disc D1. An imitated human fingerprint pattern may be provided to the lower end surface (transfer surface) of the artificial fingerprint transfer member 9; however, it is not always preferable to imitate the level of bumps and dips (the depth of bumps and dips) of a human fingerprint, and the imitation may readily become an impediment to uniform transfer of the artificial fingerprint liquid.

By specifying the setting conditions of the artificial fingerprint sticking apparatus 1 and specifying the artificial fingerprint liquid to be used, it is possible to reproducibly stick an artificial fingerprint onto an optical disc such as DVDs or Blu-ray discs, thereby making it possible to perform various types of objective evaluations. The evaluations include the following types.

(1) Evaluation of dirt repellence of optical discs:

The area ratio of an artificial fingerprint liquid drop per unit area is measured and determined to be good when it is lower than a specified threshold value.

(2) The state of an artificial fingerprint liquid drop sticking on an optical disc is observed by an optical microscope to acquire its image into a computer for image processing. The area stuck with the drop and the area stuck with no drop are measured to determine whether the disc is good or not depending on the ratio of the areas.

(3) The recording and/or reproducing properties of an optical disc stuck with an artificial fingerprint are evaluated, and the resulting properties are compared with a threshold value to determine that the disc is good when the resulting properties are better than the threshold value. For example, the recording and/or reproducing properties of an optical disc to be measured include the reflectivity during reproducing, level of modulation, and RF signal flatness; the jitter of an overwrite signal or additional write signal, output level, CN ratio, and error rate; the peak-to-peak value of a focus sensitivity curve at a linear speed during recording or reproducing; the amount of residual error of a focus error signal; and the ratio between the peak-to-peak value and the amount of residual error.

(4) Evaluation of the ease of wiping dirt (an fingerprint) sticking on the surface of an optical disc on a pass/fail basis:

The evaluations can be made in a manner such that the amount of an artificial fingerprint liquid transferred to the artificial fingerprint transfer member 9 is changed in stages, e.g., in levels 0 to 4. It is thus possible to evaluate the performance of the optical disc on a pass/fail basis in consideration of a small amount of artificial fingerprint.

More specifically, for example, in the apparatus 1 of FIG. 1, a trial shot table (not shown) which accommodates a trial shot disk may be interposed between the sample disc table 4 and the artificial fingerprint liquid transfer disk table 5. In the fourth step described with reference to FIG. 6, before the artificial fingerprint transfer member 9 (the stamp pin 6) stuck with the artificial fingerprint liquid is moved to above the test disc D1, trial shots may be allowed a predetermined number of times on the trial shot disk. To automatically follow the aforementioned procedure, it is preferable to provide drive means for rotationally driving the trial shot table by a predetermined angle, before the artificial fingerprint transfer member 9 is lowered, to prevent multiple times of trial shots from being made on the same spot.

For example, for level 0, no trial shot is made, and the artificial fingerprint transfer member 9 is pressed against the test disc D1 for a predetermined period of time. For level 1, the artificial fingerprint transfer member 9 is pressed once against the trial shot disk for a predetermined period of time, and then the artificial fingerprint transfer member 9 is pressed against the test disc D1 for a predetermined period of time. For level 2, the artificial fingerprint transfer member 9 is pressed twice against the trial shot disk each time for a predetermined period of time, and thereafter, the artificial fingerprint transfer member 9 is pressed against the test disc D1 for a predetermined period of time. For level 3, the artificial fingerprint transfer member 9 is pressed three times against the trial shot disk each time for a predetermined period of time, and thereafter, the artificial fingerprint transfer member 9 is pressed against the test disc D1 for a predetermined period of time. For level 4, the artificial fingerprint transfer member 9 is pressed four times against the trial shot disk each time for a predetermined period of time, and thereafter, the artificial fingerprint transfer member 9 is pressed against the test disc D1 for a predetermined period of time.

Employing such a method allows for adjusting the amount of the artificial fingerprint liquid sticking on the artificial fingerprint transfer member 9 in stages in the order of level 0 to level 4. This makes it possible to evaluate on a pass/fail basis the performance of an optical disc stuck with different amounts of artificial fingerprint liquid reduced in stages.

There is also another method available for adjusting in stages the amount of the artificial fingerprint liquid to be stuck onto the artificial fingerprint transfer member 9. This method includes preparing artificial fingerprint liquids which are differently diluted in stages, e.g., two times or three times. Then, they maybe used to prepare artificial fingerprint liquid transfer disks D2, e.g., for level 1 to level 4. This method allows for performing substantially the same evaluations as the aforementioned evaluations for level 1 to level 4 using trial shots.

Although the preferred examples of the present invention have been described above, the present invention is not limited thereto but also encompasses the following modified examples.

For example, it is also acceptable to eliminate the rotary actuator 15 from the artificial fingerprint sticking apparatus 1 shown in FIG. 1 as well as the artificial fingerprint liquid transfer disk table 5, so that the test disc D1 and the artificial fingerprint liquid transfer disk D2 are interchangeably placed on the sample disc table 4. According to this modified version of the artificial fingerprint sticking apparatus with the rotary actuator 15 and the artificial fingerprint liquid transfer disk eliminated, the following steps can be followed to stick an artificial fingerprint liquid onto a test disc D1.

(1) Placing an artificial fingerprint liquid transfer disk D2 on the sample disc table 4 located in a standby area.

(2) Moving the sample disc table 4 to under the stamp pin 6 (the artificial fingerprint transfer member 9).

(3) Lowering the stamp pin 6 (the artificial fingerprint transfer member 9) to press the artificial fingerprint transfer member 9 against the artificial fingerprint liquid transfer disk D2 for a predetermined period of time in order to transfer the artificial fingerprint liquid to the artificial fingerprint transfer member 9.

(4) Allowing the sample disc table 4 to return to the standby area, and then removing the artificial fingerprint liquid transfer disk D2.

(5) Placing the test disc D1 on the sample disc table 4.

(6) Moving the sample disc table 4 to under the stamp pin 6 (the artificial fingerprint transfer member 9).

(7) Lowering the stamp pin 6 (the artificial fingerprint transfer member 9) to press the artificial fingerprint transfer member 9 against the test disc D1 for a predetermined period of time in order to stick an artificial fingerprint onto the test disc D1.

(8) Allowing the sample disc table 4 to return to the standby area, and then removing the test disc D1 in order to perform evaluations on the test disc D1 stuck with the artificial fingerprint.

An operator may manually set or remove the test disc D1 and/or the artificial fingerprint liquid transfer disk D2 onto or from the sample disc table 4 and the artificial fingerprint liquid transfer disk table 5. However, an automatic disc setting machine equipped with a disc transfer arm or the like may be added to the artificial fingerprint sticking apparatus 1, thereby allowing for automatically performing these steps.

In the evaluation of the ease of wiping an optical disc, an artificial fingerprint wiping apparatus 20 shown in FIG. 7 may be preferably used. The artificial fingerprint wiping apparatus 20 includes a test sample table 22 which is rotatably driven by a motor 21, and a test disc D1 stuck with an artificial fingerprint FP is placed on the test sample table 22.

A wiping cloth 23 is placed on the test disc D1, and a weight 24 having a selected weight is placed on the wiping cloth 23. The wiping cloth 23 is connected with a cord 25 for preventing it from being rotated together with the test disc D1, and the cord 25 is fixed to a base (not shown) or the like. The wiping cloth 23 may be preferably formed of “Microstar” (registered trademark) made by TEIJIN. The “Microstar”, which is formed of ultrafine microfibers, is commercially available and utilized frequently as a cleaning cloth for optical discs.

The rotation of the motor 21 can be controlled by a controller 26, and the controller 26 is connected with rpm setting means 27 and timer setting means 28. The rpm (revolutions per minute) of the motor 21 can be arbitrarily set with the rpm setting means 27, and the operating time of the motor 21 can be arbitrarily set with the timer setting means 28. The number of actual revolutions of the motor 21 is indicated on a counter 29. The rpm of the motor 21 may be fixed and only the operating time of the motor 21 may be set with the timer setting means 28. Alternatively, the number of revolutions of the test sample table 22 may be set by the user instead of setting the operating time of the motor 21 with the timer setting means 28.

The artificial fingerprint wiping apparatus 20 can be used as follows to evaluate the ease of wiping an artificial fingerprint sticking on a test disc D1. First, the test disc D1 stuck with an artificial fingerprint is placed on the test sample table 22, and for example, a weight 24 of 31 g is also set. In addition, the rpm setting means 27 and the timer setting means 28 are used to set 670 rpm and 10 seconds, and thereafter a start switch (not shown) is turned on to start the motor 21. This causes the artificial fingerprint FP on the test disc D1 placed on the test sample table 22 to be wiped with the wiping cloth 23.

When the setting time of “10” seconds has elapsed and the motor 21 has stopped rotating, the test disc D1 is removed from the test sample table 22. Then, the evaluation of the ease of wiping the fingerprint may be made visually; however, the test disc D1 may also be set in a recording and/or reproducing apparatus to check for a skip in images or make evaluations through recording or reproducing.

Use of the artificial fingerprint wiping apparatus 20 makes it possible to wipe artificial fingerprints under a constant condition, thereby realizing objective evaluations of the ease of wiping fingerprints.

Instead of the aforementioned artificial fingerprint wiping apparatus 20, the artificial fingerprint sticking apparatus 1 can also be used to evaluate the ease of wiping fingerprints. More specifically, as shown with a phantom line in the artificial fingerprint sticking apparatus 1 of FIG. 1, the artificial fingerprint transfer member 9 may be covered from below with the wiping cloth 23 and the upper end of the wiping cloth 23 is tightened with a cord (not shown), thereby securing the wiping cloth 23 to the artificial fingerprint transfer member 9. This allows for transforming the artificial fingerprint sticking apparatus 1 into an artificial fingerprint wiping apparatus which has the wiping cloth 23 in contact with the test disc.

The artificial fingerprint sticking apparatus 1 is used as follows to wipe fingerprints. For example, a test disc D1 stuck with an artificial fingerprint is set onto the sample disc table 4 and then the arm 10 is lowered to lower the artificial fingerprint transfer member 9 having the wiping cloth 23. Thus, the artificial fingerprint transfer member 9 is now placed on the surface of the test disc D1 via the wiping cloth 23. The force exerted downwardly on the wiping cloth 23 against the test disc D1 is defined substantially by the self weight of the stamp unit 3 including the weight 8. Accordingly, the load applied to the wiping cloth 23 can be adjusted by selecting the weight of the weight 8.

The artificial fingerprint sticking apparatus 1 can be used to wipe fingerprints, e.g., by cyclically changing the direction of rotation of the servo motor 17 to move the sample disc table 4 horizontally back and forth at a given pitch. The number of times of back-and-forth movements may preferably be set arbitrarily by the user, and as means for this purpose, means for setting the number of times may be preferably provided to the controller 18.

As a modified example, a motor (not shown) for rotatably driving the sample disc table 4 may be added to the artificial fingerprint sticking apparatus 1 to wipe an artificial fingerprint sticking on the test disc D1 as with the aforementioned artificial fingerprint wiping apparatus 20. It is enough for the wiping cloth 23 to move relatively to the test disc D1 for wiping. Thus, the wiping cloth 23 may be moved horizontally or circumferentially along the plate surface of the test disc D1 for wiping.

### INDUSTRIAL APPLICABILITY

The present invention can be used for making evaluations on optical discs such as CDs and DVDs.

1. An artificial fingerprint sticking method, in which an artificial fingerprint transfer member provided at a lower end of a stamp unit is pressed against a surface of a test sample, thereby allowing an artificial fingerprint liquid sticking on the artificial fingerprint transfer member to be stuck onto the surface of the test sample, the artificial fingerprint sticking method comprising:
preparing an artificial fingerprint liquid transfer source;
positioning the artificial fingerprint liquid transfer source under the stamp unit;
lowering the stamp unit so that substantially a self weight of the stamp unit causes the artificial fingerprint transfer member to be pressed against the artificial fingerprint liquid transfer source for a predetermined time and lifting the stamp unit after the artificial fingerprint liquid is stuck onto the artificial fingerprint transfer member;
positioning the test sample under the stamp unit;
lowering the stamp unit so that substantially the self weight of the stamp unit causes the artificial fingerprint transfer member to be pressed against the test sample for a predetermined time and lifting the stamp unit after the artificial fingerprint liquid is stuck onto a surface of the test sample; and
removing the test sample stuck with the artificial fingerprint liquid from under the stamp unit.

2. An artificial fingerprint sticking apparatus for sticking a desired amount of artificial fingerprint liquid onto a surface of a test sample, the artificial fingerprint sticking apparatus comprising:
a stamp unit provided at a lower end thereof with an artificial fingerprint transfer member,
a stamp unit support for supporting the stamp unit to be slidable up and down, and
an up-and-down movement actuator for driving the stamp unit support up and down, wherein
the artificial fingerprint sticking apparatus is configured such that the up-and-down movement actuator is operated to thereby lower the stamp unit support allowing the artificial fingerprint transfer member of the stamp unit to sit on the test sample, so that substantially the self weight of the stamp unit causes the artificial fingerprint transfer member stuck with a predetermined amount of artificial fingerprint liquid to be pressed against a surface of the test sample in order to allow the artificial fingerprint liquid on the artificial fingerprint transfer member to stick onto the surface of the test sample.

3. The artificial fingerprint sticking apparatus according to claim 2, wherein the stamp unit has a weight adjustment member for adjusting the self weight of the stamp unit.

4. The artificial fingerprint sticking apparatus according to claim 2, further comprising control means for controlling the up-and-down movement actuator, and wherein
a user can define the time during which the artificial fingerprint transfer member is caused to be pressed against the test sample.

5-12. (canceled)

13. The artificial fingerprint sticking apparatus according to claim 2, further comprising:
a test sample table for the test sample to stay on, the test sample table being movable between an inner area to which the artificial fingerprint transfer member is approachable and a standby area spaced apart from the artificial fingerprint transfer member, wherein
the artificial fingerprint sticking apparatus is configured such that under a condition where the test sample table having the test sample sitting thereon is set in the inner area, the up-and-down movement actuator is operated to thereby lower the stamp unit support allowing the artificial fingerprint transfer member of the stamp unit to sit on the test sample, so that substantially a self weight of the stamp unit causes the artificial fingerprint transfer member to be pressed against the surface of the test sample in order to allow the artificial fingerprint liquid on the artificial fingerprint transfer member to stick onto the surface of the test sample.

14. The artificial fingerprint sticking apparatus according to claim 13, further comprising an artificial fingerprint liquid transfer source for supplying the artificial fingerprint liquid, and wherein
the artificial fingerprint sticking apparatus is configured such that the up-and-down movement actuator is operated to thereby lower the stamp unit support allowing the artificial fingerprint transfer member of the stamp unit to sit on the artificial fingerprint liquid transfer source, so that substantially the self weight of the stamp unit causes the artificial fingerprint transfer member to be pressed against the artificial fingerprint liquid transfer source in order to allow an artificial fingerprint liquid to stick onto the artificial fingerprint transfer member.

15. The artificial fingerprint sticking apparatus according to claim 14, wherein the artificial fingerprint liquid transfer source comprises an artificial fingerprint liquid transfer disk to which the artificial fingerprint liquid is applied.

16. The artificial fingerprint sticking apparatus according to claim 15, wherein
the test sample is an optical disc, the artificial fingerprint sticking apparatus further comprising:
an artificial fingerprint liquid transfer disk table for the artificial fingerprint liquid transfer disk to stay on, the artificial fingerprint liquid transfer disk table being movable between an inner area to which the artificial fingerprint transfer member is approachable and a standby area spaced apart from the artificial fingerprint transfer member; and
a rotary actuator for rotating the stamp unit support horizontally to locate the stamp unit support at a first rotational position and a second rotational position, and wherein
the test sample table is provided corresponding to the first rotational position of the stamp unit support, and the artificial fingerprint liquid transfer disk table is provided corresponding to the second rotational position of the stamp unit support.

17. The artificial fingerprint sticking apparatus according to claim 16, wherein
the artificial fingerprint sticking apparatus is configured such that, of the test sample table and the artificial fingerprint liquid transfer disk table, at least the test sample table is moved by a table actuator between the inner area and the standby area.

18-24. (canceled)

25. A stamp unit comprising an artificial fingerprint transfer member for transferring artificial fingerprint liquid to a surface of a test sample, the artificial fingerprint transfer member having a height of 5 to 30 mm, and an area of a transfer surface thereof being 20 to 300 mm².

26. The stamp unit according to claim 25, wherein the artificial fingerprint transfer member has a hardness of 40 to 80 HS.

27. (canceled)

28. The stamp unit according to claim 25, wherein the artificial fingerprint transfer member has a transfer surface with an arithmetic average roughness of about 0.6 to 4.5 μm.

29-30. (canceled)

31. The stamp unit according to claim 25, wherein the artificial fingerprint transfer member has either a cylindrical shape or a truncated conical shape gradually reduced downwardly in diameter.

32-33. (canceled)
